(19) United States
(12) Patent Application Publication
(10) Pub. No.: US 2005/0190123 A1
(43) Pub. Date: Sep. 1, 2005

(54) Apparatus and method for driving plasma display panel

(75) Inventors: Jeong Pil Choi, Suwon-si (KR); Byung Goo Kong, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/053,853

(22) Filed: Feb. 10, 2005

(30) Foreign Application Priority Data
Feb. 12, 2004 (KR) 10-2004-0009228

(51) Int. Cl. G09G 3/28

(52) U.S. Cl. 345/60

(57) ABSTRACT

The present invention relates to a plasma display panel, and more particularly, to an apparatus and method for driving a plasma display panel. An apparatus for driving a plasma display panel includes an energy recovery circuit having a first inductor, which is included in a path along which energy is supplied to the panel and resonate with the panel, and a second inductor included in a second path along which energy is recovered from the panel together with the first inductor. Accordingly, a plurality of inductors is serially connected so that an energy supply path and an energy recovery path are separated. It is thus possible to increase driving efficiency without changing a control signal. Further, it is possible to prevent an unnecessary resonance phenomenon by further including a clamping unit.

### CROSS-REFERENCES TO RELATED APPLICATIONS

This Nonprovisional application claims priority under 35 U.S.C. § 119(a) on Patent Application No. 10-2004-0009228 filed in Korea on Feb. 12, 2004, the entire contents of which are hereby incorporated by reference.

### BACKGROUND OF THE INVENTION

1. Field of the Invention

The present invention relates to a plasma display panel, and more particularly, to an apparatus and method for driving a plasma display panel.

2. Background of the Related Art

A common apparatus for driving a plasma display device has a sustain driving circuit that alternately applies a sustain pulse to a Y electrode and a Z electrode in order to sustain discharging of a selected cell. Such a sustain driving circuit is included in a Y electrode driver and a Z electrode driver, respectively. An energy recovery circuit is being used as the sustain driving circuit of the plasma display panel. The energy recovery circuit serves to recover energy supplied to the plasma display panel and supply it to the plasma display panel again, thereby increasing the use efficiency of energy.

FIG. 1 is a circuit diagram of a conventional energy recovery circuit. FIG. 2 shows a waveform of a sustain pulse depending upon driving of the conventional energy recovery circuit and variation in current flowing through an inductor of the conventional energy recovery circuit. As shown in FIGS. 1 and 2, the operation of the conventional energy recovery circuit consists of four steps.

In the first state State 1, a first switch S1 is turned on and second to fourth switches S2, S3 and S4 are turned off. Accordingly, as energy stored in a capacitor Css is supplied to a panel Cp, Vp rises. In the first state, the current flowing through an inductor L becomes +IL since the energy flows from the capacitor Css to the panel Cp, as shown in FIG. 2.

In the second state (State 2), the first switch S1 and the second switch S2 are turned on, and the third switch S3 and the fourth switch S4 are turned off. Accordingly, Vp becomes a sustain voltage Vcc. At the moment when the first state (State 1) is finished, i.e., at the moment when Vp becomes the highest value Vcc in t1 by means of LC resonance, the voltage Vcc is applied to the panel Cp.

Thereafter, in the third state (State 3), the third switch S3 is turned, and the first, second and fourth switches S1, S2 and S4 are turned off. Accordingly, as the energy stored in the panel Cp is discharged toward a capacitor CS, the energy is recovered and Vp drops. In the third state, the current flowing through the inductor L becomes IL since the current flows from the panel Cp to the capacitor Css, as shown in FIG. 2.

Lastly, in the fourth state (State 4), the third switch S3 and the fourth switch S4 are turned on, and the first, second and third switches S1, S2 and S3 are turned off. Accordingly, Vp becomes a ground level. At the moment when the third state (State 3) is finished, i.e., in t2, Vp keeps the ground level. The sustain pulse is formed through such four states.

The conventional energy recovery circuit includes only one inductor L in order to recover and supply energy. Since energy is supplied to the panel is recovered from the panel through one inductor, the current path for the supply and recovery of energy is the same. Therefore, the circuit pattern of the conventional energy recovery circuit is stably formed on a PCB (Printed Circuit Board).

Meanwhile, the conventional energy recovery circuit uses only one inductor when performing the supply and recovery of energy. Thus, there occurs a problem related to efficiency. That is, the higher inductance of the inductor, the greater power consumption increases. Therefore, driving efficiency of the energy recovery circuit increases, whereas the voltage of the sustain pulse smoothly increases. This makes strong discharge difficult and thus causes discharge efficiency to lower.

### SUMMARY OF THE INVENTION

Accordingly, the present invention has been made in view of the above problems, and it is an object of the present invention to provide an apparatus and method for driving a plasma display panel, wherein driving efficiency and discharge efficiency can be increased.

To achieve the above object, according to the present invention, there is provided an energy recovery circuit for recovering energy by supplying energy to a panel, including a first inductor included in a first path along which energy is supplied to the panel, and a second inductor included in a second path along which energy is recovered from the panel together with the first inductor.

In the second path, the first inductor and the second inductor are connected in a serial manner.

The first inductor has a value lower than that of the second inductor.

The energy recovery circuit further includes a clamping unit for keeping a first voltage, which is applied to the panel, constant.

The clamping unit includes a first clamping unit for clamping a voltage higher than the first voltage applied to the panel.

The clamping unit further includes a second clamping unit for clamping a voltage lower than the first voltage applied to the panel.

### BRIEF DESCRIPTION OF THE DRAWINGS

Further objects and advantages of the invention can be more fully understood from the following detailed description taken in conjunction with the accompanying drawings in which:

FIG. 1 is a circuit diagram of a conventional energy recovery circuit;

FIG. 2 shows a waveform of a sustain pulse depending upon driving of the conventional energy recovery circuit and variation in current flowing through an inductor of the conventional energy recovery circuit;

FIG. 3 is a circuit diagram of an energy driving circuit according to a first embodiment of the present invention;

FIG. 4 show a waveform of a sustain pulse according to a first embodiment of the present invention;

FIG. 5 is a circuit diagram of an energy recovery circuit according to a second embodiment of the present invention;

FIG. 6 is a graph for explaining the operation of the energy recovery circuit according to the second embodiment of the present invention;

FIG. 7 is a circuit diagram of an energy recovery circuit according to a third embodiment of the present invention; and

FIG. 8 is a graph for explaining the operation of the energy recovery circuit according to the third embodiment of the present invention.

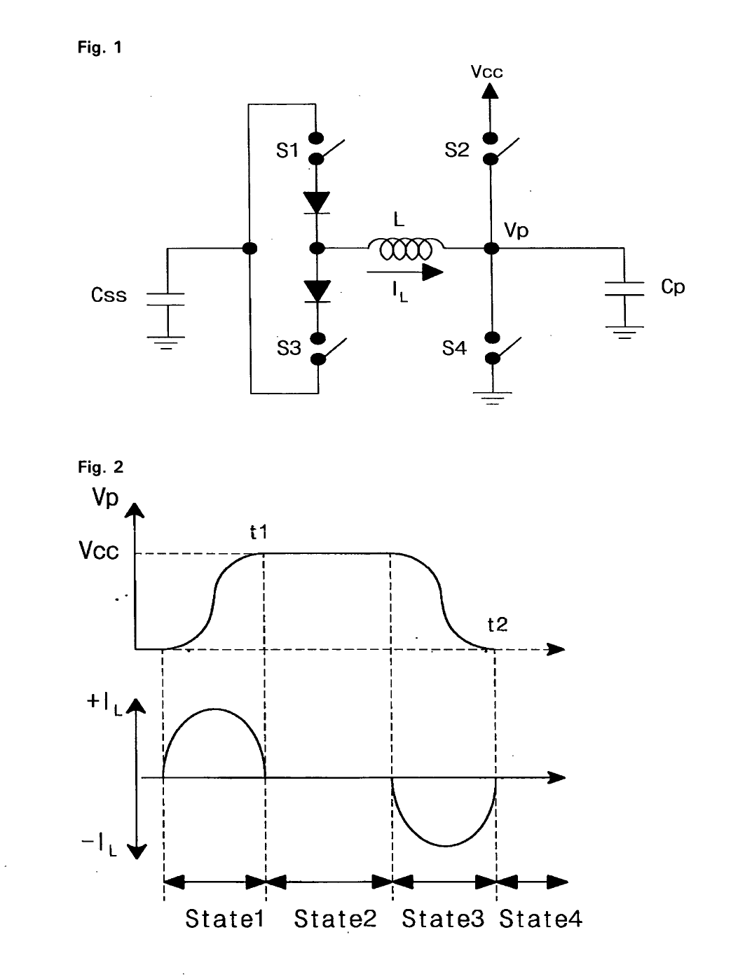

### DETAILED DESCRIPTION OF THE PREFERRED EMBODIMENT

The present invention will now be described in detail in connection with preferred embodiments with reference to the accompanying drawings.

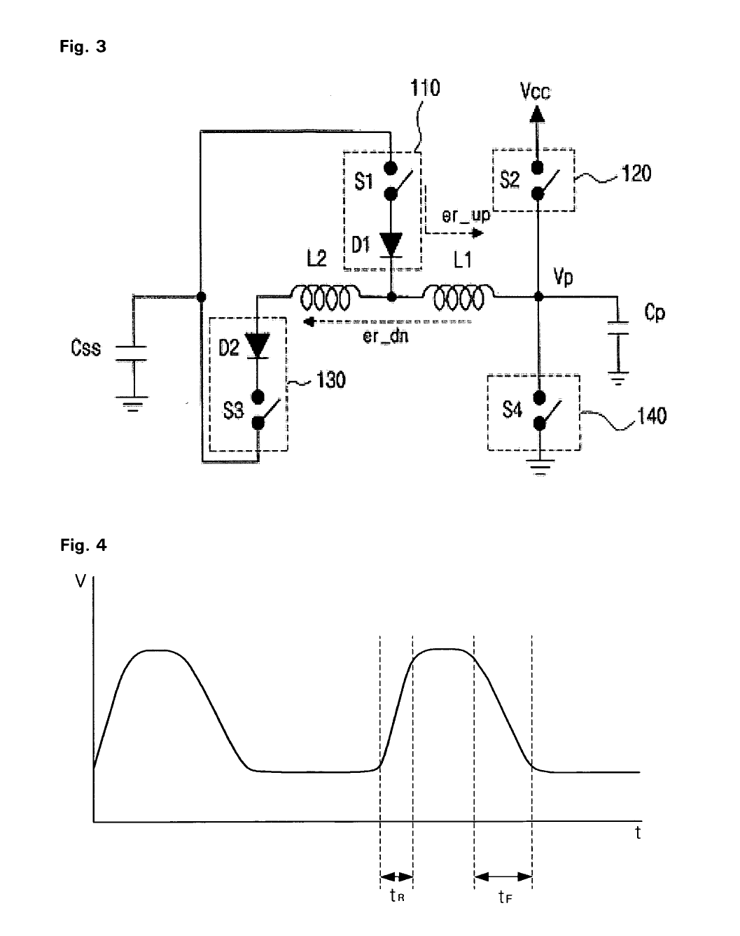

FIG. 3 is a circuit diagram of an energy driving circuit according to a first embodiment of the present invention. Referring to FIG. 3, the energy driving circuit according to a first embodiment of the present invention includes a first switch unit 110, a first inductor L1, a second switch unit 120, a third switch unit 130, a second inductor L2, and a fourth switch unit 140.

<First Switch Unit>

The first switch unit 110 is turned on to supply energy stored in a supply/recovery capacitor Css to a panel Cp. This first switch unit 110 includes a first switch S1 and a first diode D1, as shown in FIG. 3.

<First Inductor>

The first inductor L1 forms an energy supply path along which energy is supplied to the panel Cp together with the first switch unit 110 when the first switch unit 110 is turned on, so that a voltage Vp applied to the panel Cp becomes a first voltage by means of LC resonance.

<Second Switch Unit>

The second switch unit 120 is turned on when the voltage Vp applied to the panel Cp becomes a first voltage Vp, so that the first voltage is kept. At this time, the first voltage is a sustain voltage Vcc.

<Third Switch Unit>

The third switch unit 130 is turned on so that the energy stored in the panel Cp is recovered to the supply/recovery capacitor Css. This third switch unit 130 includes a third switch and a second diode, as shown in FIG. 3.

<Second Inductor>

The second inductor L2 forms an energy recovery path together with the first inductor L1 when the third switch unit 130 is turned on, so that the voltage Vp applied to the panel Cp becomes a second voltage Vp by means of LC resonance. At this time, the second inductor is connected to the first inductor in a serial manner.

<Fourth Switch Unit>

The fourth switch unit 140 is turned when the voltage Vp applied to the panel Cp becomes the second voltage Vp, so that the second voltage is kept. At this time, the second voltage is a ground level.

One end of the first inductor L1, one end of the second inductor L2, and the first switch unit 110 of the energy recovery circuit according to the first embodiment of the present invention are interconnected. Therefore, if the first switch unit 110 is turned on, the first inductor L1 and the second inductor L2 are serially connected.

The operation of the energy recovery circuit according to the first embodiment of the present invention is composed of the following four states.

In the first state, the first switch unit 110 is turned on, and the remaining second to fourth switch unites 120, 130 and 140 are turned off. Accordingly, energy stored in the supply/recovery capacitor Css is supplied to the panel Cp.

At this time, usually, Css is fixed to ½ Vcc, and a left terminal of the first inductor L1 thus becomes ½ Vcc. If the first switch unit 110 is turned on, the left terminal of the first inductor L1 is ½ Vcc, whereas a right terminal thereof becomes 0V. In this case, current flows from the left terminal to the right terminal of the first inductor L1. Thus, Vp reaches ½ Vcc. At this time, the current flowing through the first inductor L1 generates counter electromotive force, and the Vp value resultantly becomes Vcc.

The path of energy supplied thus is the supply/recovery capacitor Css—the first switch—the first diode—the first inductor—the panel Cp. The first inductor forms LC resonance together with the panel Cp, and causes the voltage that is applied to the panel Cp to become the first voltage, which is the same as the sustain voltage Vcc.

In the second state, the second switch unit 120 is turned on and the remaining switch units are turned off. Accordingly, the panel Cp is applied with the sustain voltage Vcc and the first voltage is thus kept.

In the third state, the third switch unit 130 is turned on and the remaining switch units are turned off. Accordingly, the energy stored in the panel Cp is recovered to the supply/recovery capacitor Css. The path of the energy recovered thus is the panel Cp—the first inductor L1—the second inductor L2—the third switch unit 130—the supply/recovery capacitor Css.

In the fourth state, the fourth switch unit 140 is turned on and the remaining switch units are turned off. Accordingly, the voltage Vp applied to the panel becomes the ground level.

In the energy recovery circuit according to the first embodiment of the present invention, the energy supply path and the energy recovery path are different. That is, when energy is supplied, it is supplied only through the first inductor L1. When energy is recovered, it is recovered through the first inductor L1 and the second inductor L2, which are serially connected.

Accordingly, when energy is supplied, it is supplied by the inductance of the first inductor L1. Further, when energy is recovered, it is recovered by the sum of the inductance of the first inductor L1 and the inductance of the second inductor L2.

Thus, if the first inductor L1 of a low inductance is used in the energy supply operation, discharge efficiency can be increased since a voltage rising time becomes relatively fast. In the energy recovery operation having no connection with discharge, however, driving efficiency is increased because the inductance is increased due to the sum of the inductance of the first inductor L1 and the inductance of the second inductor L2.

In the energy recovery circuit according to the present invention, the inductance value of the first inductor L1 and the inductance value of the second inductor L2 can be freely set. Thus, there is an advantage in that driving margin can be sufficiently secured.

In this case, if the inductance of the second inductor L2 is higher than that of the first inductor L1, the efficiency of the energy recovery circuit according to the present invention is improved. This is because in the energy supply process, the lower the inductance, the better the efficiency, and in the energy recovery process, the higher the inductance, the better the efficiency.

Meanwhile, according to the present invention, the inductance values of the first inductor L1 and the second inductor L2 can be set to be the same. In this case, the process can be simplified.

FIG. 4 show a waveform of a sustain pulse according to a first embodiment of the present invention.

From FIG. 4, it can be seen that tR of a sustain pulse is smaller than a falling time tF of the sustain pulse. This is because the voltage rising time becomes relatively fast since the first inductor L1 of a low inductance is used in the energy supply operation, and energy is recovered due to the sum of the inductance of the first inductor L1 and the inductance of the second inductor L2 in the energy recovery operation.

Usually, according to the present invention, the rising time tR of the sustain pulse, wherein sustain discharge can be smoothly performed, is about 400 μs or less. The falling time tF of an efficient sustain pulse is 400 μs or more.

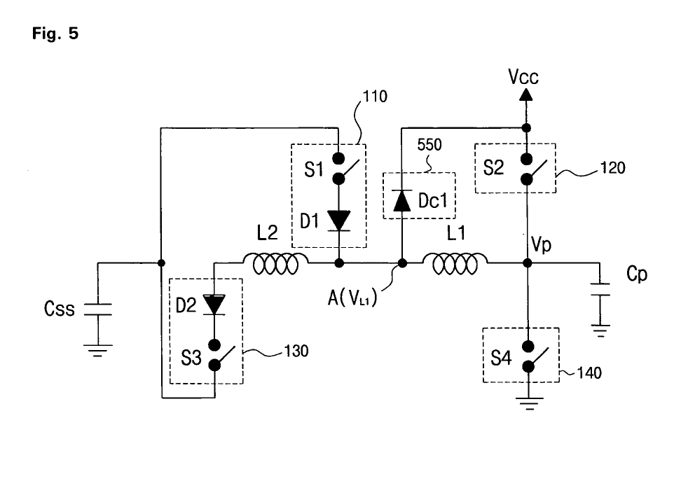

FIG. 5 is a circuit diagram of an energy recovery circuit according to a second embodiment of the present invention.

As can be seen from FIG. 5, the second embodiment is different from the first embodiment in that a clamping unit 550 is added to the energy recovery circuit of the first embodiment. At this time, the clamping unit 550 includes a clamping diode Dc1. The cathode terminal of the clamping diode Dc1 is connected to the sustain voltage source Vcc, and the anode terminal thereof is commonly connected to the first inductor L1 and the second inductor L2.

The energy recovery circuit according to the second embodiment of the present invention clamps a voltage higher than the sustain voltage source Vcc.

The first switch unit 110 is turned on, and the voltage Vp applied to the panel Cp thus reaches the voltage of the sustain voltage source Vcc. Thereafter, the second switch unit 120 is turned on, and the voltage Vp applied to the panel Cp keeps the sustain voltage Vcc.

At this time, the current flowing through the first inductor L1 becomes 0. Further, since a voltage is not applied to a point A due to turning off of the first, third and fourth switch units, the first inductor L1 becomes a floating state. In this floating state, a voltage V_{L1} at the point A is influenced by the voltage Vp applied to the panel Cp. Therefore, unnecessary resonance is generated.

In other words, as the second switch is turned on, the left terminal of the first inductor L1 rises from ½ Vcc to Vcc, which is the value of the voltage Vp applied to the panel Cp. At this time, counter electromotive force is generated again in the first inductor L1. Thus, the left terminal of the first inductor L1 increases to 3/2 Vcc when the clamping diode Dc1 does not exist. If the clamping diode Dc1 exists, however, the current flows through the clamping diode Dc1, and the voltage is stabilized to Vcc, which is supplied externally.

The clamping unit 550 used in the second embodiment clamps a voltage in which the voltage V_{L1} at the point A is higher than the sustain voltage source Vcc, thereby minimizing unnecessary resonance. Since unnecessary resonance is removed as such, the efficiency of the energy recovery circuit according to the present invention is further improved. Furthermore, since the third switch unit 130 is turned off in the energy supply process, the clamping unit 550 prevents even unnecessary resonance generated due to the second inductor L2.

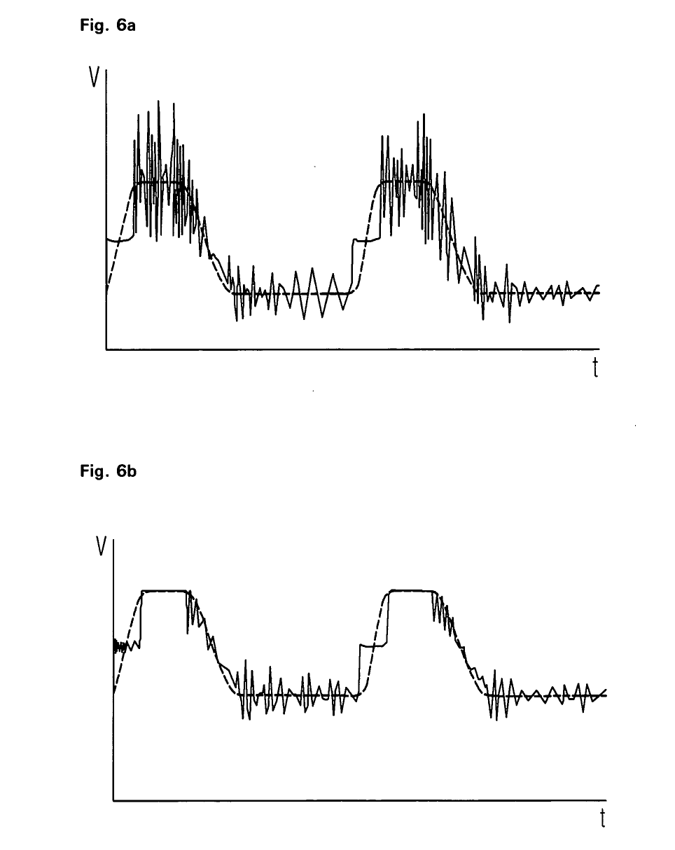

FIGS. 6a and 6b are graphs for explaining the operation of the energy recovery circuit according to the second embodiment of the present invention.

FIG. 6a schematically shows a waveform when the clamping unit 550 does not exist. FIG. 6b schematically shows a waveform when the clamping unit 550 exists. From FIGS. 6a and 6b, it can be seen that unnecessary resonance is minimized by the clamping unit 550 after the second switch unit 120 is turned on.

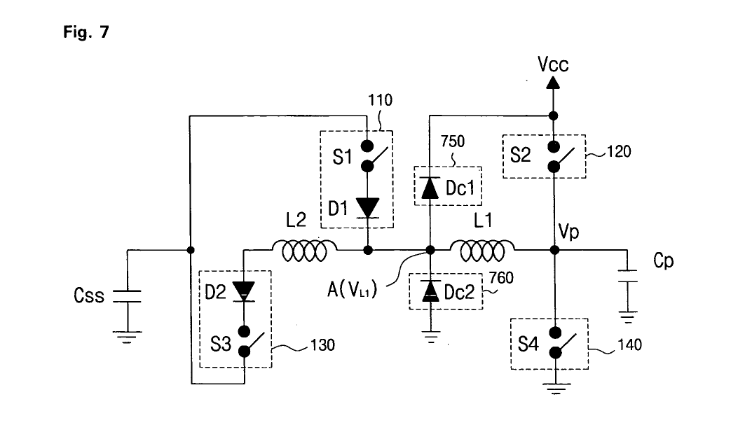

FIG. 7 is a circuit diagram of an energy recovery circuit according to a third embodiment of the present invention.

As shown in FIG. 7, the third embodiment includes two clamping units, i.e., a first clamping unit 750 and a second clamping unit 760. The clamping units have clamping diodes Dc1, Dc2, respectively. Since the operation and construction of the first clamping unit 750 are the same as those of the clamping unit included in the second embodiment, a detailed description thereof will be omitted.

The cathode terminal of the second clamping diode Dc2 is commonly connected to the first inductor L1 and the second inductor L2. The anode terminal of the second clamping diode Dc2 is connected to the ground level.

The third switch unit 130 is turned on, and the voltage Vp applied to the panel Cp thus drops to the ground level. Next, the fourth switch unit 140 is turned on, and the voltage Vp applied to the panel Cp is kept to the ground level.

At this time, the current flowing through the second inductor L2 becomes 0. Since a voltage is not applied to the point A due to turning off of the first, second and third switch units, the second inductor L2 becomes a floating state.

In this floating state, the voltage V_{L1} at the point A is influenced by the voltage Vp applied to the panel Cp. Thus, unnecessary resonance is generated.

The second clamping unit 760 included in the third embodiment clamps a voltage in which the voltage V_{L1} at the point A is lower than the ground level, thereby minimizing unnecessary resonance.

That is, the left terminal of the first inductor L1 is ½ Vcc, whereas the right terminal of the first inductor L1 is connected to the ground level. Thus, the voltage Vp applied to the panel Cp becomes 0v. Accordingly, the current flows from the left terminal to the right terminal of the first inductor L1, and the voltage of the first inductor L1 becomes 0v. At this time, counter electromotive force is generated in the first inductor L1. Thus, if the second clamping unit 760 does not exist, the voltage Vp applied to the panel Cp becomes a voltage (−½ Vcc), which is lower than 0v. The second clamping unit 760 clamps a voltage lower than the ground level, thus minimizing unnecessary resonance.

As unnecessary resonance is removed as such, the efficiency of the energy recovery circuit according to the present invention is further improved.

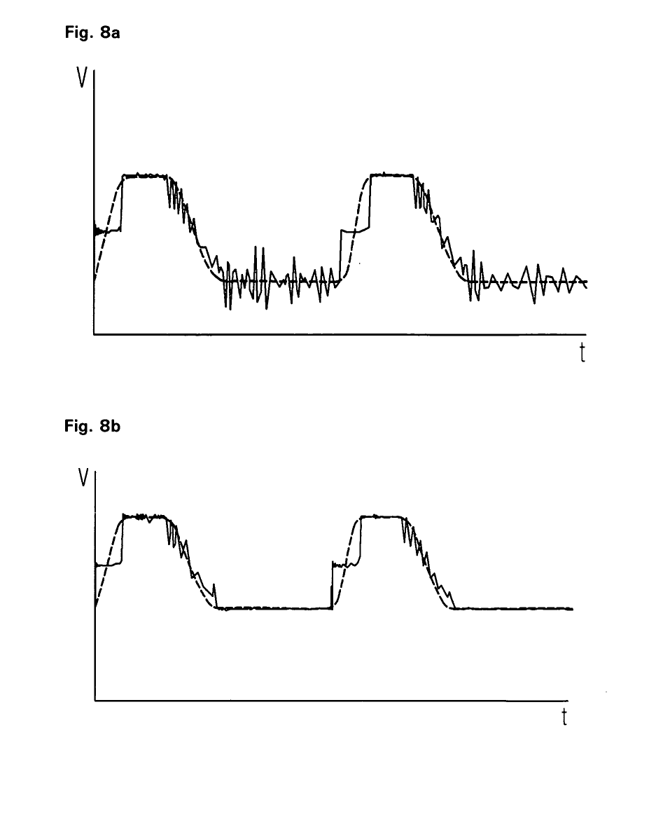

FIGS. 8a and 8b are graphs for explaining the operation of the energy recovery circuit according to the third embodiment of the present invention. FIG. 8a schematically shows a waveform when only the first clamping unit 750 exists. FIG. 8b schematically shows a waveform when the first clamping unit 750 and the second clamping unit 760 exist.

From FIGS. 8a, 8b, it can be seen that only unnecessary resonance occurring the energy supply process is minimized when only the first clamping unit 750 exists, whereas unnecessary resonance occurring in the energy recovery process as well as the energy supply process is minimized when the first clamping unit 750 and the second clamping unit 760 exist.

As described above, according to the present invention, a plurality of inductors is serially connected so that an energy supply path and an energy recovery path are separated. It is thus possible to increase driving efficiency without changing a control signal. Further, the present invention has an advantage in that it can prevent an unnecessary resonance phenomenon by further including a clamping unit.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An energy recovery circuit for recovering energy by supplying energy to a panel, comprising:
a first inductor included in a first path along which energy is supplied to the panel; and
a second inductor included in a second path along which energy is recovered from the panel together with the first inductor.

2. The energy recovery circuit as claimed in claim 1, wherein the first inductor and the second inductor are serially connected in the second path.

3. The energy recovery circuit as claimed in claim 1, further comprising a clamping unit for maintaining a uniform first voltage applied to the panel.

4. The energy recovery circuit as claimed in claim 3, wherein the clamping unit comprises a first clamping unit for clamping a voltage higher than the first voltage applied to the panel.

5. The energy recovery circuit as claimed in claim 4, wherein the clamping unit further comprises a second clamping unit for clamping a voltage lower than the first voltage applied to the panel.

6. The energy recovery circuit as claimed in claim 4, wherein the first clamping unit has an anode terminal commonly connected to the first inductor and the second inductor, and has a cathode terminal connected to a voltage source for supplying the first voltage.

7. The energy recovery circuit as claimed in claim 5, wherein the second clamping unit has an anode terminal connected to a ground level, and a cathode terminal commonly connected to the first inductor and the second inductor.

8. The energy recovery circuit as claimed in claim 1, wherein the first inductor has a value lower than that of the second inductor.

9. The energy recovery circuit as claimed in claim 1, wherein the first inductor has the same value as that of the second inductor.

10. An apparatus for driving a plasma display panel including an energy recovery circuit for recovering energy by supplying energy to a panel, comprising:
a first inductor included in a first path along which energy is supplied to the panel; and
a second inductor included in a second path along which energy is recovered from the panel together with the first inductor.

11. The apparatus as claimed in claim 10, wherein the first inductor and the second inductor are serially connected in the second path.

12. The apparatus as claimed in claim 10, wherein further comprising a clamping unit for maintaining a uniform first voltage applied to the panel.

13. The apparatus as claimed in claim 10, wherein the clamping unit comprises a first clamping unit for clamping a voltage higher than the first voltage applied to the panel.

14. The apparatus as claimed in claim 13, wherein the clamping unit further comprises a second clamping unit for clamping a voltage lower than the first voltage applied to the panel.

15. The apparatus as claimed in claim 13, wherein the first clamping unit has an anode terminal commonly connected to the first inductor and the second inductor, and a cathode terminal connected to a voltage source for supplying the first voltage.

16. The apparatus as claimed in claim 14, wherein the second clamping unit has an anode terminal connected to a ground level, and a cathode terminal commonly connected to the first inductor and the second inductor.

17. The apparatus as claimed in claim 10, wherein the first inductor has a value lower than that of the second inductor.

18. The apparatus as claimed in claim 10, wherein the first inductor has the same value as that of the second inductor.

19. An apparatus for driving a plasma display panel including an energy recovery circuit having a first inductor for supplying energy to a panel, and a second inductor for recovering energy from the panel together with the first inductor,
wherein an rising time of a pulse supplied to the panel through the first inductor is shorter than a falling time of a pulse recovered from the panel through the first inductor and the second inductor.

20. The apparatus as claimed in claim 19, wherein the pulse rising time is shorter than the pulse falling time.

21. The apparatus as claimed in claim 19, wherein the first inductor has a value lower than that of the second inductor.

22. The apparatus as claimed in claim 19, wherein the first inductor has the same value as that of the second inductor.

23. The apparatus as claimed in claim 19, wherein the pulse rising time is below 400 μs

24. The apparatus as claimed in claim 19, wherein the pulse falling time is over 400 μs

25. A method of driving a plasma display device including an energy recovery circuit having a first inductor for supplying energy to a panel, and a second inductor for recovering energy from the panel together with the first inductor, comprising the steps of:
(a) allowing a pulse, which is supplied to the panel through the first inductor, to reach a first voltage during a pulse rising time;
(b) allowing the pulse supplied to the panel to maintain the first voltage;
(c) allowing a pulse, which is recovered through the first inductor and the second inductor, to reach a ground voltage during a pulse falling time; and
(d) allowing the pulse applied to the panel to maintain the ground voltage.

26. The method as claimed in claim 25, wherein the pulse rising time is shorter than the pulse falling time.

27. The method as claimed in claim 25, wherein the first inductor has a value lower than that of the second inductor.

28. The method as claimed in claim 25, wherein the first inductor has the same value as that of the second inductor.

29. The method as claimed in claim 25, wherein the pulse rising time is below 400 μs

30. The method as claimed in claim 25, wherein the pulse falling time is above 400 μs

31. The method as claimed in claim 25, wherein in step (a), a first switch unit is turned on, and second to fourth switch units are turned off.

32. The method as claimed in claim 25, wherein in step (b), a second switch unit is turned on, and first, third and fourth switch units are turned off.

33. The method as claimed in claim 25, wherein in step (c), a third switch unit is turned on, and first, second and fourth switch units are turned off.

34. The method as claimed in claim 25, wherein in step (d), a fourth switch unit is turned on, and first, second and third switch units are turned off.
